(19) United States
(12) Patent Application Publication
(10) Pub. No.: US 2008/0270834 A1
(43) Pub. Date: Oct. 30, 2008

(54) CONTROL METHOD FOR READ OPERATION OF MEMORY

(75) Inventor: Wei-Li Liu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NANYA TECHNOLOGY CORPORATION, Taoyuan (TW)

(21) Appl. No.: 11/852,336

(22) Filed: Sep. 10, 2007

(30) Foreign Application Priority Data
Apr. 24, 2007 (TW) 96114413

(51) Int. Cl. G06F 11/36

(52) U.S. Cl. 714/33; 714/E11.167

(57) ABSTRACT

Received read commands and address signals are respectively decoded into internal column strobe signals and internal address signals for reading data out of a data storage portion of a memory. A waiting interval during which a readout data becomes ready is simulated or a transmission path on which the readout data is transmitted is simulated. When the simulation result indicates the readout data is ready, an error check operation is performed on the readout data. The operation interval of the error check is simulated. When the simulation for the error check operation indicates that the error check is completed, an error check result is sent out of the memory.

### CROSS-REFERENCE TO RELATED APPLICATION

This application claims the priority benefit of Taiwan application serial no. 96114413, filed Apr. 24, 2007. All disclosure of the Taiwan application is incorporated herein by reference.

### BACKGROUND OF THE INVENTION

1. Field of the Invention

The present invention relates to a method of controlling the operation of a memory. More particularly, the present invention relates to a method of controlling the operation of a memory, which can enhance a correct rate of data reading.

2. Description of Related Art

Dynamic random access memory (DRAM) is adopted in many electronic system products as the optimal and indispensable memory solution due to its advantages of low cost and large capacity. Presently, DRAM is mainly used in information products, such as desktop computers, notebook computers, DRAM upgrade modules, servers, and workstations etc.

In a communication system or a computer system, a cyclic redundancy check (CRC) algorithm can be used to enhance error check capability of the DRAM. After data transmission or data storage, CRC can be used to check whether errors occur in the course of data transmission. During data transmission, both a receiver and a sender need CRC operation, and one of the receiver and the sender compares the CRC results calculated by the both parties, and thus whether the received data is correct can be recognized.

When the CRC is used to enhance the correct rate of read data of a memory, the CRC operation cannot be performed until data is ready. If the CRC operation is performed before data is ready, the obtained CRC operation result is incorrect.

Furthermore, in the DRAM, some data buses may be shared. When the data is read continuously, if the timing of the CRC operation is not controlled, data hazards easily occur. Especially, when the CRC operation is timing-consuming, if the CRC operation has not been completed and next batch of data arrives, errors may easily occur.

Furthermore, if the occasion that the CRC operation is completed may be estimated, occupation of the data buses can be released as soon as possible after the CRC operation is completed and sent out through the data buses. As such, the reading speed of the DRAM can be accelerated.

Therefore, it is desired to provide a method of controlling the read operation of the DRAM to solve the disadvantages of the conventional art and provide other advantages.

### SUMMARY OF THE INVENTION

The present invention is directed to provide a method of controlling read operation of a DRAM, which can accurately simulate/estimate when data is ready.

The present invention is directed to provide a method of controlling read operation of a DRAM, which can accurately simulate/estimate when the CRC operation is completed.

The present invention is directed to provide a method of controlling read operation of a DRAM, which can further avoid data hazards during the read process.

The present invention is directed to provide a method of controlling read operation of a DRAM, which can further avoid outputting an incorrect CRC operation result.

The present invention is directed to provide a method of controlling read operation of a DRAM, which can further enhance the reading speed.

One example of a method of controlling the operation of a memory provided by the present invention includes decoding a read command into an internal column strobe signal and decoding an input address signal into an internal address signal. According to the internal column strobe signal and the internal address signal, data is read out of the memory. A data transmission through which the readout data becomes ready is simulated, so as to indicate whether the readout data is ready. When the simulation result of the data transmission indicates that the readout data is ready, an error check operation is performed on the readout data, so as to check whether the readout data is correct. The operation interval of the error check is simulated, so as to indicate whether the error check operation is completed. When the simulation result of the error check operation indicates that the error check operation is completed, the error check result is sent out of the memory.

Furthermore, another example of a method of controlling the operation of a memory provided by the present invention includes decoding a read command into an internal column strobe signal and decoding an input address signal into an internal address signal. According to the internal column strobe signal and the internal address signal, data is read out of a data storage portion of the memory. The readout data is sent to an error check unit in the memory, so as to check whether the readout data is correct. The operation interval of the error check unit is simulated, so as to indicate whether the error check is completed. When the error check simulation result indicates that the error check operation is completed, the error check result generated by the error check unit is sent out of the memory.

Furthermore, still another example of a method of controlling the operation of a memory is provided by the present invention. The memory includes at least a memory cell array, a data register, and an error check unit. The method includes receiving and decoding a read command into an internal column strobe signal and an input address signal into an internal address signal respectively. According to the internal column strobe signal and the internal address signal, data is read out of the memory cell array. The readout data is sent out of the memory. The data transmission through which the data is read out of the memory cell array and arrives at the data register is simulated, so as to generate a data ready signal. According to the data ready signal, the readout data is transmitted from the data register to the error check unit. The error check operation is performed on the readout data by the error check unit, so as to generate an error check code. The operation interval of the error check of the error check unit is simulated, so as to output an error check ready signal. According to the error check ready signal, the error check code generated by the error check unit is sent out of the memory.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of controlling reading of a memory according to an embodiment of the present invention.

FIG. 2 is a schematic view of reading simulation in this embodiment.

### DESCRIPTION OF EMBODIMENTS

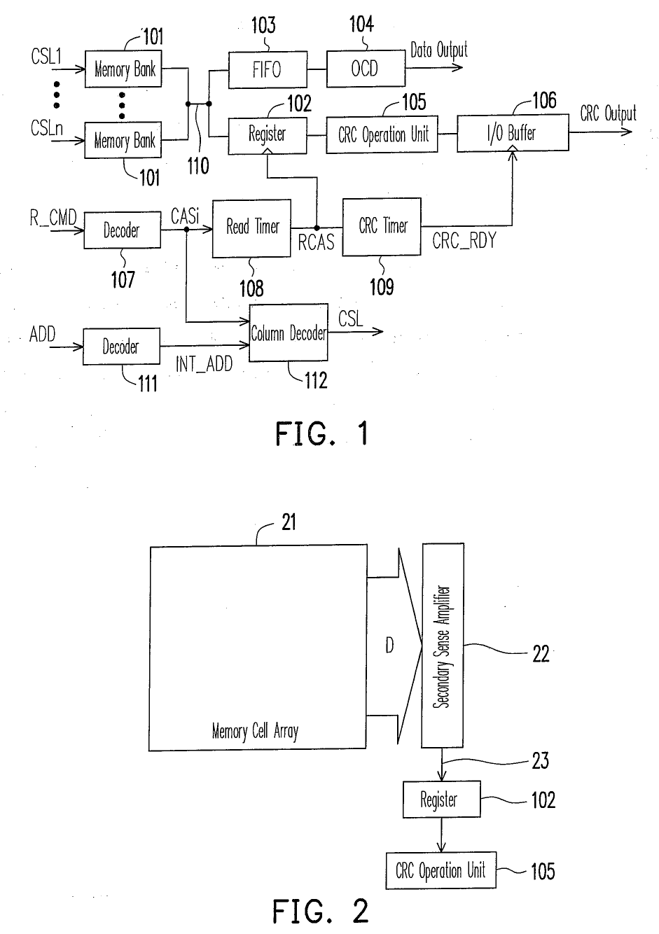

Referring to FIG. 1, a schematic view of controlling reading of a memory according to an embodiment of the present invention is shown. Memory banks 101 are coupled to a register 102 and an FIFO (First In First Out) register 103 through a data bus 110. A CRC operation unit 105 is coupled to the register 102 and an I/O buffer 106. An off-chip driver (OCD) 104 is coupled to the FIFO register 103. A decoder 107 is coupled to a read timer 108. A CRC timer 109 is coupled to the read timer 108 and the I/O buffer 106. The decoder 111 is coupled to a column decoder 112.

Data read out of the memory banks 101 is transmitted to the register 102 and the FIFO register 103 through the data bus 110.

The register 102 is used to temporarily store the readout data, such that the CRC operation unit 105 performs CRC operation on the readout data.

The FIFO register 103 is also used to temporarily store the readout data, such that the readout data can be sent out of the memory. Data from the FIFO register 103 passes through the OCD 104 to adjust an operating voltage thereof.

In a DDR (Double Data Rate) II DRAM, the OCD can correct the working voltage of an I/O buffer of the DRAM to enhance the consistency of the working voltage, thereby improving signal quality. The level of a drive voltage thereof is adjusted according to the distance between the DRAM and other elements. If the signal line is long, a high drive voltage is required, and vice versa. The operation of the OCD includes setting the resistance of the I/O buffer to adjust the drive voltage thereof, so as to compensate a pull-up/pull-down resistance. The signal integrity can be improved through minimizing a data skew. The over-shooting and under-shooting are controlled to improve the signal quality. The process difference of different DRAM manufacturers can be modified through correcting the voltage of the I/O buffer. Through the correction of the OCD 104, the data can be output out of the memory through the I/O buffer.

The CRC operation unit 105 performs the CRC operation on the readout data. The CRC operation unit 105 may include multiple stages of logic gates (for example, EXOR logic gates). For example, when the readout data includes 128 bits, the CRC operation unit 105 may include seven stages of EXOR logic gates, but the quantities of the EXOR logic gates in each stage may be different.

The I/O buffer 106 receives a CRC operation result calculated by the CRC operation unit 105 and a CRC ready signal CRC_RDY generated by the CRC timer 109. The CRC ready signal CRC_RDY controls the I/O buffer 106 to determine whether to output the CRC operation result. In this embodiment, when the CRC ready signal CRC_RDY appears, it indicates that the CRC operation unit 105 completes the CRC operation and generates the correct CRC operation result. As such, the I/O buffer 106 can send the CRC operation result.

The decoder 107 may decode a read command R_CMD into an internal CAS (column address strobe) signal CASi. When the internal CAS signal CASi appears, it indicates starting point of data reading in a memory cell array. The decoder 111 can also decode a received address signal ADD into an internal address signal INT_ADD.

The read timer 108 generates a data read ready signal RCAS according to the internal CAS signal CASi generated by the decoder 107. The read timer 108 is used to simulate a waiting interval from receiving of the read command R_CMD to data output from the memory chip, or the signal path thereof. Through the timing simulation of the read timer 108, it may be ensured that during the CRC operation, the CRC operation is performed on the required data instead of the previous batch of data. Furthermore, if the simulation result is closely approximate to the actual reading interval, the interval between data reading to starting of the CRC operation may further be reduced, thereby enhancing the operating speed of the memory. That is to say, after it is ensured that data is necessary, the CRC operation is started as early as possible, so as to enhance the operating speed.

The objects simulated by the read timer 108 are at least: (1) a memory cell array, (2) a secondary sense amplifier, and (3) a data transmission path (i.e., a metal line) between the secondary sense amplifier and the register 102. Definitely, the objects simulated by the read timer 108 are determined depending on the internal architecture of the memory, and are only examples for illustration herein. In this embodiment, the read timer 108 can be implemented in several manners.

One possible implementation architecture of the read timer 108 may include (1) simple simulation circuits for the memory cell array, for simulating data transmission paths in the memory cell array, (2) simple simulation circuits for the secondary sense amplifier, for simulating data transmission paths of the secondary sense amplifier, and (3) simulation metal lines for simulating data transmission paths (metal lines) between the secondary sense amplifier and the register 102. In order to make the simulation more accurate, for example, the length of the simulation metal lines in (3) is equal to the length of the metal lines between the secondary sense amplifier and the register 102. The two kinds of the metal lines may be in different layout. For example, the metal lines between the secondary sense amplifier and the register 102 may be straight line, while the simulation metal lines in (3) can be deviously. Definitely, if the architecture/layout of the memory cell array, the secondary sense amplifier, or the metal lines between the secondary sense amplifier and the register 102 is/are changed, the architecture/layout of the read timer 108 must be changed accordingly.

The electrical characteristics of the memory cell array, the secondary sense amplifier, and the metal lines between the secondary sense amplifier and the register 102 may be slightly changed due to the possible process drift. In this simulation, if the process drift occurs, the simulation result of the read timer 108 drifts accordingly. That is, if the process drift accelerates (slows down) the electrical characteristics of the simulation circuits, the simulation result is accelerated or (slowed down) accordingly.

Another possible implementation architecture of the read timer 108 may include a plurality of delay units. The total delay time (for example, clock cycles) of these delay units may ensure that data has been read out of the memory cell array and been transmitted to the register 102. However, if the frequency of the clock cycle becomes higher, it must be noted whether the total delay time is sufficient to cover the actual data reading interval. Under this architecture, the data read ready signal RCAS may be regarded as a delay signal of the internal CAS signal CASi.

The CRC timer 109 is used to simulate the CRC operation time of the CRC operation unit 105. The CRC timer 109 generates the CRC ready signal CRC_RDY according to the data read ready signal RCAS. When the CRC ready signal CRC_RDY appears, it indicates that the CRC operation unit 105 has completed the CRC operation. In this embodiment, the CRC timer 109 also has several possible implementation architectures.

One possible implementation architecture of the CRC timer 109 is related to the architecture of the CRC operation unit 105. For example, as described above, when the CRC operation unit 105 includes seven stages of EXOR logic gates, the CRC timer 109 may include seven serially-connected EXOR logic gates. As such, the delay time (representing the actual time for the CRC operation) between an output signal and an input signal of the CRC operation unit 105 may be approximately equal to the delay time (representing the simulated CRC operation time) between an output signal and an input signal of the CRC timer 109.

Another possible implementation architecture of the CRC timer 109 includes a plurality of delay units. The total delay time (for example, clock cycles) of the delay units must ensure that the CRC operation unit 105 has completed the CRC operation. However, if the frequency of the clock cycle becomes higher, it must be noted that the total delay time is sufficient to cover the actual CRC operation. Under such an architecture, the CRC ready signal CRC_RDY may be regarded as a delay signal of the data read ready signal RCAS.

The column decoder 112 decodes the internal CAS signal CASi (decoded by the decoder 107) and the internal address signals INT_ADD (decoded by the decoder 111) into a column select line signal CSL. The column select line signal CSL includes signals CSL1-CSLn which are respectively sent to one of the memory banks 101 to indicate that which memory bank 101 is to be opened for sending data.

Furthermore, for example, a receiver can be used to receive an external read signal (regarded as the read command R_CMD) and an external address signal (regarded as the address signal ADD).

Referring to FIG. 2, a schematic view of reading simulation in this embodiment is shown. As shown in FIG. 2, the memory cell array 21 is coupled to the secondary sense amplifier 22. The secondary sense amplifier 22 is coupled to the register 102 through the data bus 23. The register 102 is coupled to the CRC operation unit 105.

When one of the columns of the memory cell array 21 is opened, data D is sent to the register 102 through the secondary sense amplifier 22 and the data bus 23. In this embodiment, the reading interval simulated by the read timer 108 is the transmission interval during which the data is sent out of the memory cell array (i.e., the column is opened) and then arrives at the register 102 through the secondary sense amplifier 22 and the data bus 23.

Herein, the data bus 23 may be a long metal line (for example, the metal line 1000 μm long).

This embodiment may be applied to not only a single read command, but also continuous read commands.

In view of the above, in the embodiment of the present invention, through reading interval simulation, the timing of data transmitted from the memory cell array to the data register may be estimated, so as to prevent using incorrect (or unnecessary) data in the CRC operation.

Furthermore, through simulating the timing required by the CRC operation, the CRC operation result may be prevented from being sent out before the CRC operation is completed, thereby enhancing the correctness of the output timing of CRC.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of controlling an operation of a memory, comprising:
decoding a read command into an internal column strobe signal;
decoding an address signal into an internal address signal;
reading data out of the memory according to the internal column strobe signal and the internal address signal;
simulating a data transmission through which the readout data becomes ready, so as to indicate whether the readout data is ready;
when the simulation result of the data transmission indicates that the readout data is ready, performing an error check operation on the readout data, so as to check whether the readout data is correct;
simulating an operation interval of the error check, so as to indicate whether the error check operation is completed; and
when the simulation result of the error check operation indicates that the error check operation is completed, sending the error check result out of the memory.

2. The method of controlling the operation of a memory as claimed in claim 1, wherein the step of simulating the data transmission comprises:
simulating a data transmission path on which the data is read out of a data storage portion of the memory and transmitted to a data register in the memory.

3. The method of controlling the operation of a memory as claimed in claim 1, wherein the step of simulating the data transmission comprises:
delaying the internal column strobe signal; and
indicating that the readout data is ready based on the delayed internal column strobe signal.

4. The method of controlling the operation of a memory as claimed in claim 1, wherein the step of simulating the operation interval of the error check comprises:
simulating a circuit architecture of an error check unit in the memory for executing the error check operation.

5. The method of controlling the operation of a memory as claimed in claim 1, wherein the step of simulating the operation interval of the error check comprises:
delaying the simulation result of the data transmission that indicates that the readout data is ready; and
indicating that the error check operation is completed based on the delayed simulation result of the data transmission.

6. The method of controlling the operation of a memory as claimed in claim 1, wherein the step of reading the data out of the memory according to the internal column strobe signal and the internal address signal comprises:
decoding the internal column strobe signal and the internal address signal into a column select line signal; and
reading the data out of the memory according to the column select line signal.

7. A method of controlling the operation of a memory, comprising:
decoding a read command into an internal column strobe signal;
decoding an address signal into an internal address signal;
reading data out of a data storage portion of the memory, according to the internal column strobe signal and the internal address signal;
sending the readout data to an error check unit in the memory, so as to check whether the readout data is correct;
simulating the operation interval of the error check unit, so as to indicate whether the error check is completed; and
when the error check simulation result indicates that the error check operation is completed, sending the error check result generated by the error check unit out of the memory.

8. The method of controlling the operation of a memory as claimed in claim 7, wherein the step of simulating the operation interval of the error check unit comprises:
simulating a circuit architecture of the error check unit.

9. The method of controlling the operation of a memory as claimed in claim 7, wherein the step of simulating the operation interval of the error check unit comprises:
delaying the simulation result of the data transmission that indicates that the readout data is ready; and
indicating that the error check operation is completed, based on the delayed simulation result of the data transmission.

10. The method of controlling the operation of a memory as claimed in claim 7, wherein the step of reading the data out of the data storage portion of the memory according to the internal column strobe signal and the internal address signal comprises:
decoding the internal column strobe signal and the internal address signal into a column select line signal and
according to the column select line signal, reading the data out of the memory.

11. A method of controlling the operation of a memory, wherein the memory at least comprises a memory cell array, a data register, and an error check unit, the method comprising:
receiving and decoding a read command into an internal column strobe signal;
decoding an address signal into an internal address signal;
reading a data out of the memory cell array, according to the internal column strobe signal and the internal address signal;
sending the readout data out of the memory;
simulating the data transmission through which the data is read out of the memory cell array and arrives at the data register, so as to generate a data ready signal;
transmitting the readout data out of the data register to the error check unit, according to the data ready signal;
performing an error check operation on the readout data by the error check unit, so as to generate an error check code;
simulating the operation interval of the error check operation of the error check unit, so as to output an error check ready signal; and
sending the error check code generated by the error check unit out of the memory, according to the error check ready signal.

12. The method of controlling the operation of a memory as claimed in claim 11, wherein:
the memory further comprises a secondary sense amplifier, and a data bus between the secondary sense amplifier and the data register;
the step of simulating the data transmission comprises:
simulating a transmission path on which the readout data is sent from the memory cell array, passes through the secondary sense amplifier and the data bus, and arrives at the data register.

13. The method of controlling the operation of a memory as claimed in claim 11, wherein the step of simulating the data transmission comprises:
delaying the internal column strobe signal; and
indicating that the readout data is ready, based on the delayed internal column strobe signal.

14. The method of controlling the operation of a memory as claimed in claim 11, wherein the step of simulating the operation interval of the error check operation of the error check unit comprises:
simulating a circuit architecture of the error check unit.

15. The method of controlling the operation of a memory as claimed in claim 11, wherein the step of simulating the operation interval of the error check operation of the error check unit comprises:
delaying the data ready signal; and
indicate that the error check operation is completed, based on the delayed data ready signal.

16. The method of controlling the operation of a memory as claimed in claim 11, wherein the step of reading the data out of the memory cell array according to the internal column strobe signal and the internal address signal comprises:
decoding the internal column strobe signal and the internal address signal into a column select line signal; and
reading the data out of the memory cell array, according to the column select line signal.
